(19) United States
(12) Patent Application Publication
(10) Pub. No.: US 2005/0092546 A1
(43) Pub. Date: May 5, 2005

(54) Safety belt device having warning device

(76) Inventor: Samuel Wen-Chih Hsu, Taichung (TW)

Correspondence Address: Samuel Wen-Chih Hsu, P.O. Box 63-298, Taichung, 406, TW

(21) Appl. No.: 10/702,788

(22) Filed: Nov. 4, 2003

(51) Int. Cl. A62B 1/16

(52) U.S. Cl. 182/6

(57) ABSTRACT

A safety belt device is used for coupling users to support members and to suspend and space the users from the ground when the users fell out of the support members, and includes a warning device attached and arranged to generate warning signals when the safety belt device is extended or stretched by such as the users, in order to ask help from other people. The safety belt device includes two belt members, and the warning device is attached between the two belt members. A buffer device may be attached between the belt members to buffer the safety belt, and to provide a cushioning force against the safety belt device.

### BACKGROUND OF THE INVENTION

1. Field of the Invention

The present invention relates to a safety belt device, and more particularly to a safety belt device for protecting workers at high elevation, and having a warning device for generating warning signals to ask help from others when accidents happened.

2. Description of the Prior Art

For protecting workers who are working at high elevations or buildings or architectures, safety nets will be attached to the lower portion of the buildings or architectures, for receiving and supporting the workers fell from the buildings or architectures, and for preventing the workers from directly fell down to the ground.

In addition to the safety nets, various kinds of safety belts have also been developed to be hooked or secured between the workers and the buildings or architectures, to suspend the workers and to prevent the workers from directly fell down to the ground when accidents happened.

Normally, the typical safety belts comprise two hooks or latches attached to the ends thereof, for hooking or securing to the workers and the buildings or architectures respectively, and to suspend and space the workers from the ground when the workers fell out of the buildings or architectures inadvertently.

However, in some of the accidents, when the workers fell out of the buildings or architectures and suspended at high levels by the safety belts, the workers may be unconscious and may not ask help from others.

The present invention has arisen to mitigate and/or obviate the afore-described disadvantages of the conventional safety belts.

### SUMMARY OF THE INVENTION

The primary objective of the present invention is to provide a safety belt device for workers at high elevation having a warning device for generating warning signals to ask help from others when accidents happened.

The other objective of the present invention is to provide a safety belt device having a buffer device for preventing the workers from directly fell down to the ground when accidents happened.

In accordance with one aspect of the invention, there is provided a safety belt device comprising a belt body for coupling users to support members, and a warning device attached to the belt body, to generate warning signals when the belt body is extended or stretched, or when the users fell out of the support members, in order to ask help from other people.

The belt body includes a first belt member and a second belt member, the warning device is attached between the first belt member and the second belt member of the belt body. The warning device is attached to the first belt member, and includes an actuator member extended therefrom and attached to the second belt member of the belt body.

The warning device includes a warning member for generating warning sounds, and/or the warning device includes a warning member for generating warning lights.

A buffer device may further be provided and attached to the belt body, and to buffer the belt body. The buffer device includes a strap having two end portions coupled to the belt body, and arranged to allow the strap to be extended before the belt body is completely extended.

The buffer device further includes a band having two end coupled to the end portions of the strap, and arranged to allow the band to be extended before the strap is completely extended. The band includes a folded intermediate portion, and the folded intermediate portion of the band is preferably stitched together with stitches.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial plan schematic view illustrating the operation of a safety belt device in accordance with the present invention, for supporting or suspending workers at high elevation;

FIG. 2 is a perspective view of the safety belt device;

FIG. 3 is a partial plan schematic view illustrating a buffer device and a warning signal generating device of the safety belt device; and

FIG. 4 is a partial perspective view of the buffer device of the safety belt device.

### DETAILED DESCRIPTION OF THE PREFERRED EMBODIMENT

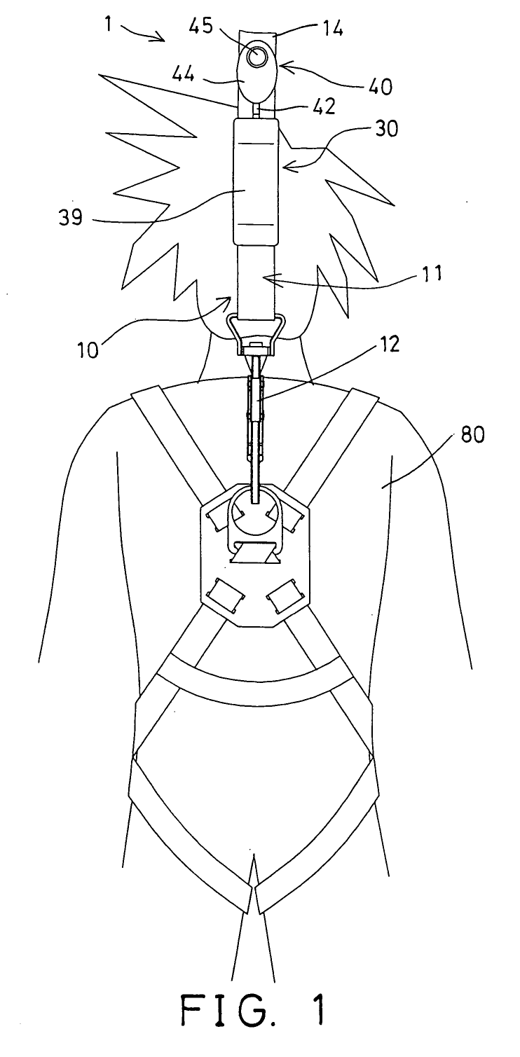

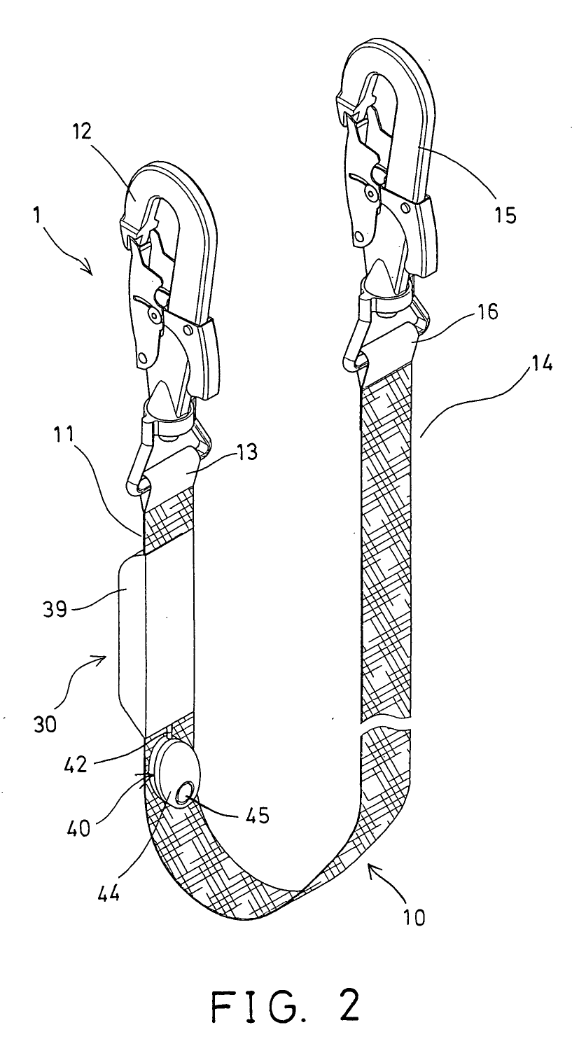

Referring to the drawings, and initially to FIGS. 1 and 2, a safety belt device in accordance with the present invention is generally indicated with a reference numeral “1” and comprises a belt body 10 including a fastener member 12, such as a latch or hook 12 provided on one end for attaching to the workers 80 (FIG. 1) for example, and another fastener member 15 provided on the other end for attaching to the supporting members, such as the buildings or architectures, etc. (not shown).

For example, the belt body 10 includes a belt member 11 having the fastener member 12 attached to one end 13 thereof, and another belt member 14 having the other fastener member 15 attached to one end 16 thereof. The fastener members 12, 15 may be hooked or attached to the supporting members for suspending the workers 80 from the ground or for preventing the workers 80 from directly fell down to the ground when accidents happened.

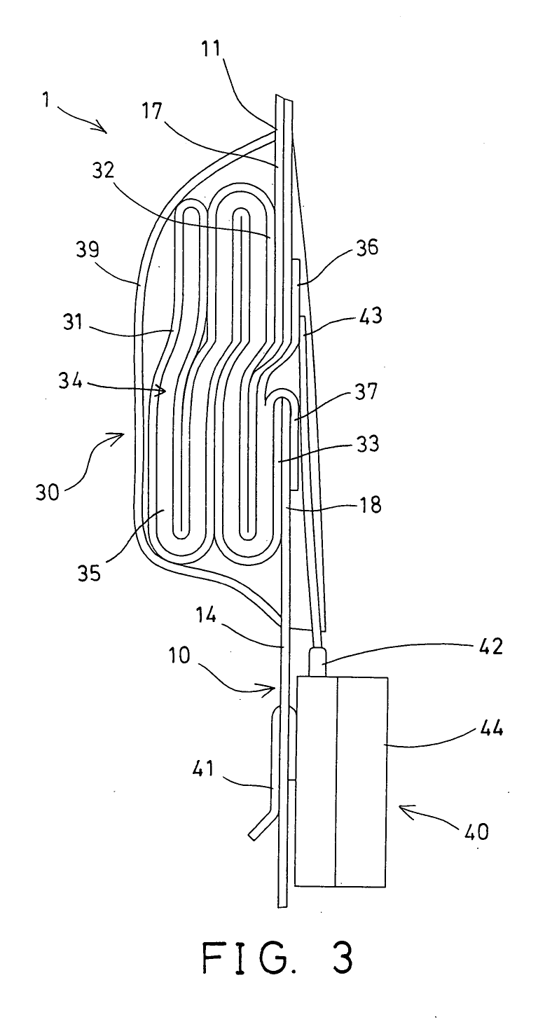

A buffer device 30 may be optionally or selectively attached to the belt body 10, such as secured between the other ends 17, 18 of the belt members 11, 14 of the belt body 10 (FIG. 3), to provide a buffer or cushioning force to the belt body 10 and thus to the workers 80, to prevent the belt body 10 from being directly and completely stretched when the workers 80 fell out of the buildings or architectures inadvertently, for example.

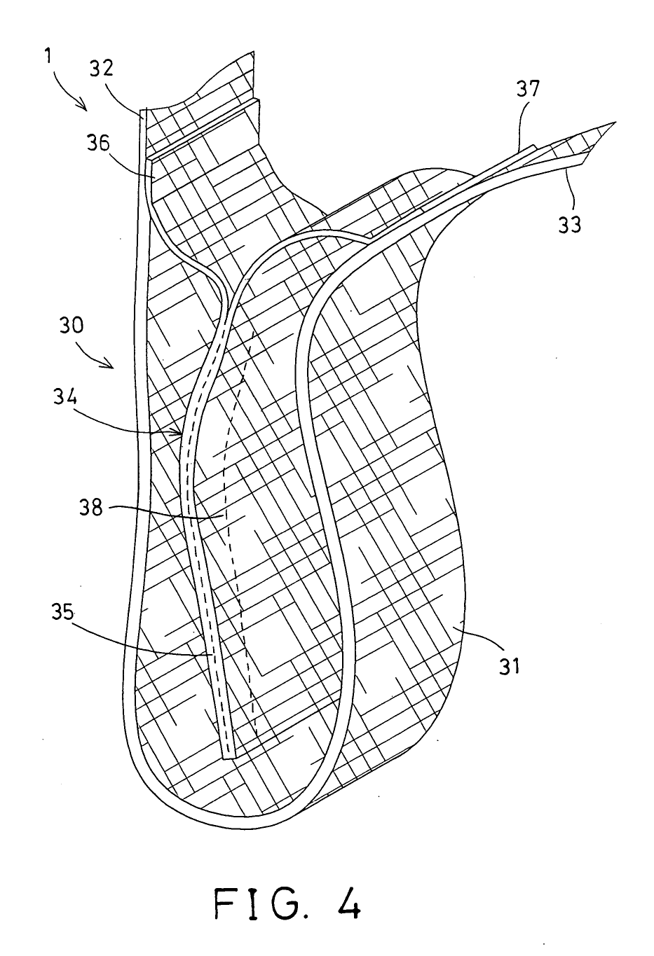

As shown in FIGS. 3 and 4, the buffer device 30 includes a strap 31 having two end portions 32, 33 coupled to the other ends 17, 18 of the belt members 11, 14 of the belt body 10, and a band 34 having two ends 36, 37 coupled to the end portions 32, 33 of the strap 31 respectively. The band 34 preferably includes an intermediate portion 35 folded and secured together with such as adhesive materials, stitches 38, etc.

In operation, when the strap 31 is pulled or extended or stretched by such as the belt members 11, 14, and when the workers 80 fell out of the buildings or architectures inadvertently, for example, the stitches 38 of the band 34 may be broken and may be used to prevent the strap 31 from being directly and quickly extended or stretched, such that the band 34 may provide a buffer or cushioning force to the strap 31 and thus to the belt body 10 and the workers 80.

It is preferable that the band 34 includes a length no greater than that of the strap 31, to allow the band 34 to be completely stretched before the strap 31 may be completely stretched. It is also preferable that the band 34 is made of resilient materials, to further provide a spring biasing force or buffer or cushioning force to the strap 31 and the belt body 10 and the workers 80. A cap or cover 39 may be attached to the belt body 10, in order to receive and shield and protect the buffer device 30.

It is to be noted that the ends 17, 18 of the belt members 11, 14 may also be solidly secured together as a one-integral piece. The two ends 36, 37 of the band 34, and/or the end portions 32, 33 of the strap 31 may be secured to an intermediate portion of the belt body 10 that is folded or arranged in a loosely folded configuration, similar to the relationship between the strap 31 and the band 34, to allow the strap 31 and the band 34 to be extended and/or stretched before the belt body 10 is fully or completely extended or stretched.

The belt body 10 further includes a warning device 40 for generating warning signals to ask help from others when accidents happened, for example. The warning device 40 may be attached or secured to such as the belt member 14 of the belt body 10 with clips 41 (FIG. 3), latches, fasteners (not shown), or the like, and includes an actuator member 42, such as an actuator pin 42, extended therefrom and having one end 43 attached or secured to the belt member 11 or to the end portion 32 of the strap 31.

The actuator member 42 of the warning device 40 is arranged to be actuated or operated when the belt body 10 is extended or stretched, or when the two belt members 11, 14 are stretched or pulled away from each other, or when the two end portions 32, 33 of the strap 31 are stretched or pulled away from each other, or when the band 34 is extended or stretched.

The warning device 40 includes a warning member 44, such as a buzzer, a light device or the like, for generating warning sounds, and/or flash lights, or the like, when the actuator member 42 is actuated or operated by either the belt body 10, the belt members 11, 14, the strap 31, or the band 34. The warning device 40 further includes a control button 45 for actuating or operating the warning member 44, such as for switching on and off the warning member 44 to generate warning sounds, and/or flash lights.

Accordingly, the safety belt device in accordance with the present invention includes a warning device for generating warning signals to ask help from others when accidents happened.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A safety belt device comprising:
a belt body, and
a warning device attached to said belt body, to generate warning signals when said belt body is extended.

2. The safety belt device as claimed in claim 1, wherein said belt body includes a first belt member and a second belt member, said warning device is attached between said first belt member and said second belt member of said belt body.

3. The safety belt device as claimed in claim 2, wherein said warning device is attached to said first belt member, and includes an actuator member extended therefrom and attached to said second belt member of said belt body.

4. The safety belt device as claimed in claim 1, wherein said warning device includes a warning member for generating warning sounds.

5. The safety belt device as claimed in claim 1, wherein said warning device includes a warning member for generating warning lights.

6. The safety belt device as claimed in claim 1 further comprising a buffer device attached to said belt body, and to buffer said belt body.

7. The safety belt device as claimed in claim 6, wherein said buffer device includes a strap having two end portions coupled to said belt body, and arranged to allow said strap to be extended before said belt body is completely extended, and to provide a cushioning force against said belt body.

8. The safety belt device as claimed in claim 7, wherein said buffer device further includes a band having two end coupled to said end portions of said strap, and arranged to allow said band to be extended before said strap is completely extended.

9. The safety belt device as claimed in claim 8, wherein said band includes a folded intermediate portion.

10. The safety belt device as claimed in claim 9, wherein said folded intermediate portion of said band is stitched together with stitches.

11. The safety belt device as claimed in claim 7, wherein said buffer device further includes a cover attached to said belt body, and to enclose said strap of said buffer device.
